(19) United States
(12) Patent Application Publication
(10) Pub. No.: US 2011/0228752 A1
(43) Pub. Date: Sep. 22, 2011

(54) System and method to pack cellular systems and WiFi within a TV channel

(76) Inventor: Shiquan Wu, Ottawa (CA)

(21) Appl. No.: 13/064,165

(22) Filed: Mar. 9, 2011

Related U.S. Application Data
(60) Provisional application No. 61/282,721, filed on Mar. 22, 2010.

(51) Int. Cl. H04W 84/02

(52) U.S. Cl. 370/338

(57) ABSTRACT

An inventive system allows GSM as a master signaling and timing system to operate WiFi within a TV channel. GSM system will broadcast system information regularly and GSM unit of the terminal will regularly wake up to check those system information and wakeup messages to keep being associated with G-WiFi base station. WiFi units of the G-WiFi system will be dormant and become active when triggered by GSM counterparts. There is provided a method to partition the TV channel among GSM or CDMA or TD-SCDMA or 1xEVDO and WiFi system. GSM frequencies for uplink and downlink may not have a deterministic relationship and may be assigned dynamically. This method can be applied to other frequency band to allow GSM, WiFi, TD-SCDMA, CDMA, WCDMA etc to share an available spectrum such as the current GSM spectrum, TD-SCDMA spectrum etc.

### CLAIM OF PRIORITY

This patent application claims the benefit of priority from U.S. Provisional Patent Application No. 61/282,721 filed on Mar. 22, 2010. This application incorporates by reference the entire disclosure of U.S.A. Provisional Patent Application No. 61/282,721.

### 1. FIELD OF THE INVENTION

This invention relates generally to TV spectrum re-farming for other wireless communication systems such as GSM, WiFi, WiMax, CDMA/WCDMA and 3GPP/LTE.

### 2. BACKGROUND OF THE INVENTION

In the United States, the Federal Communications Commission (FCC) mandated transition from analogy to digital TV at Jun. 12, 2009. After this transition, the TV channels that will not be used by broadcasters in the respective region can be reused by other wireless communication systems. This regionally available spectrum is called “TV band white space (TVWS)”. There were 68 (2˜69) TV broadcasting channels (refer FIG. 1) and each occupies 6 MHz wide spectrum (other geographic region can be 7 MHz or 8 MHz). The FCC had allocated channels 2 through 51 (refer to FIG. 2) to HDTV which will use Advanced Television Systems Committee (ATSC) standards; Other TV channels (52˜69) had been reallocated and auctioned for other wireless systems.

TV spectrum is world wide applicable and is in lower frequencies. Signals at lower frequency have less propagation loss and wall penetration loss. Lower frequencies are ideal for other wireless services such as voice, broadband internet, security and emergency, machine to machine communications etc.

GSM is a world wide dominant wireless cellular communications system and owns more than 80% of the wireless subscribers. GSM network has the best coverage so far and its signal is almost everywhere. Electronics related to GSM system are very economical and mature due to its past 20 years development and commercialization.

GSM is a FDD-TDMA (Frequency-Division-Duplex-Time-Division-Multiplex-Access) system. Each carrier occupies 200 kHz which is time shared by eight time slots or 8 users. The downlink (from base station to terminal) channel frequency and the uplink (from terminal to base station) channel frequency are predefined and are in pair, i.e. base station transmission frequency has a constant distance relative to mobile transmission frequency. A typical example of the frequency channels, time slots and their relationship are shown in FIG. 3 where if we know mobile transmission frequency fl, then the base station frequency can be calculated as fu=fl+45. A standardized spectrum mask is depicted in FIG. 4.

The GSM slot structure for different types of slots (also called bursts) is illustrated in FIG. 5 (Refer to 3GPP TS 05.02, Release 99). There are 5 types of bursts: (1) a Normal burst to carry data and control information; (2) a frequency correction burst transmitted by base station and used by a terminal for acquiring base station frequency information; (3) a synchronization burst transmitted by base station and used by a terminal to find downlink timing, (4) an Access burst transmitted by a terminal for random access and handover access, and (5) a dummy burst used for rate adaptation and matching purposes.

In early generation of GSM, for each burst/slot, a total of 156.25 bits are transmitted in 0.577 milliseconds, giving a gross bit rate of 270.833 kbps. In each normal burst/slot, 26 bit training sequence in the middle are used for channel tracking, 3 tail bits (TB) on both ends are used for reset the Viterbi equalizer state in a receiver, and the last 8.25 bits guard time allows power ramp up and down to handle some propagation time delay in the arrival of bursts to ensure that the data slots do not collide with each other. Therefore each normal burst can carry 114 information bits which are equally loaded to the left hand side and right hand side of the 26 training sequence bits.

The frames and slots numerology are illustrated in FIG. 6. Each group of eight time slots is called a TDMA frame, which is transmitted every 4.615 ms. TDMA frames are further grouped into multi-frames to carry control signals. There are two types of multi-frame, containing either 26 or 51 TDMA frames. The 26 frame multi-frame contains 24 Traffic Channels (TCH) and 2 Slow Associated Control Channels (SACCH) which supervises each call in progress. The SACCH in frame 12 contains eight channels, one for each of the eight connections carried by the TCHs. The SACCH in frame 25 is not currently used, but will carry eight additional SACCH channels when half rate traffic is implemented. A Fast Associated Control Channel (FACCH) works by stealing slots from a traffic channel to transmit power control and handover signaling messages. The channel stealing is done by setting one of the control bits in the burst.

In addition to the Associated Control Channels, there are several other control channels which (except for the Standalone Dedicated Control Channel) are implemented in time slot 0 of specified TDMA frames in a 51 frame multiframe, implemented on a non-hopping carrier frequency in each cell. These control channels include:
Broadcast Control Channel (BCCH): Continually broadcasts, on the downlink, information including base station identity, frequency allocations, and frequency hopping sequences etc.
Standalone Dedicated Control Channel (SDCCH): Used for registration, authentication, call setup, and location updating. Implemented on a time slot, together with its SACCH, selected by the system operator.
Common Control Channel (CCCH): Comprises three control channels used during the call origination and call paging.
   Random Access Channel (RACH): A slotted Aloha channel to request access to the network.
   Paging Channel: Used to alert the mobile station of incoming call.
   Access Grant Channel (AGCH): Used to allocate an SDCCH to a mobile for signaling, following a request on RACH.

The primary GSM is circuit connection oriented network and mainly for voice services. Other usage such as short massage is very powerful as well. General Radio Packet Service (GPRS) is packet switch oriented network on top of GSM network and is specified by ETSI/3GPP standards group. We will briefly illustrate how to provide these services in physical layer before we describe the new invention.

GSM is a digital communication system. The speech signals, inherently analog, have to be digitized. The GSM group studied several voice coding algorithms on the basis of subjective speech quality and complexity (which is related to cost, processing delay, and power consumption once implemented) before arriving at the choice of a Regular Pulse Excited-Linear Predictive Coder (RPELPC) with a Long Term Predictor loop. In practice, information from previous samples, which do not change very quickly, is used to predict the current sample. The coefficients of the linear combination of the previous samples, plus an encoded form of the residual (the difference between the predicted and actual sample), represent the signal. Speech is divided into 20 millisecond samples, each of which is encoded as 260 bits, giving a total bit rate of 13 kbps (refer FIG. 7).

Recall that the speech codec produces a 260 bit block for every 20 ms speech sample. From subjective testing, it was found that some bits of this block were more important for perceived speech quality than others. The bits are thus divided into three classes:
Class Ia 50 bits—most sensitive to bit errors
Class Ib 132 bits—moderately sensitive to bit errors
Class II 78 bits—least sensitive to bit errors

Class Ia bits have a three-bit Cyclic Redundancy Code added for error detection. If an error is detected in the receiver, the frame is judged too damaged to be comprehensible and it is discarded. It is then replaced by a slightly attenuated version of the previous correctly received frame. These 53 bits, together with the 132 Class Ib bits and a four-bit tail sequence (a total of 189 bits), are input into a ½ rate convolution encoder of constraint length five. Each input bit is encoded as two output bits, based on a combination of the previous four input bits. The convolution encoder thus outputs 378 bits, to which are added the 78 remaining Class II bits, which are unprotected. Thus every 20 ms speech sample is encoded as 456 bits, giving a bit rate of 22.8 kbps. FIG. 7 further illustrates how this process is implemented.

To further protect against the burst errors common to the radio interface, the 456 bits output from the convolution encoder are interleaved and then divided into eight blocks of 57 bits (refer to 3GPP TS 05.03, release 99), and these blocks are transmitted in eight consecutive timeslot bursts. Since each timeslot burst can carry two 57 bit blocks, each burst carries traffic from two successive speech blocks of 20 ms each. FIG. 8 illustrates this interleaving process in detail.

Each timeslot burst is transmitted at a gross bit rate of 270.833 kbps. The modulating symbol rate is 1/T=1,625/6 ksymbols/s (i.e. approximately 270.833 ksymbols/s). This digital signal is modulated onto the analog carrier frequency, which has a channel bandwidth of 200 kHz, using Gaussian Filtered Minimum Shift Keying (GMSK).

GMSK Modulation Start and Stop of the Burst (Refer 3GPP TS 05.04, Release 1999). Before the first bit of the burst, as defined in 3GPP TS 05.02, enters the modulator, the modulator has an internal state as if a modulating bit stream consisting of consecutive ones (di=1) had entered the differential encoder. Also after the last bit of the time slot, the modulator has an internal state as if a modulating bit stream consisting of consecutive ones (di=1) had continued to enter the differential encoder. These bits are called dummy bits and define the start and the stop of the active and the useful part of the burst. Nothing is specified about the actual phase of the modulator output signal outside the useful part of the burst.

FIG. 9 shows the relationship between active part of burst, tail bits and dummy bits. For the normal burst, the useful part lasts for 147 modulating bits.

In order to transmit the packet data in GSM framework, GPRS MAC layer (also called RLC—radio link control) will first fragment the data unit received from upper layer (say TCP/IP layer) into segments. Each segment then goes through a process that includes padding some overhead bits, convolution encoding, puncturing if necessary to make radio blocks of 456 bits each. As each burst only can carry 114 bits, this 456 bits will be further divided into 4 equal groups and each has 114 bits. Then each group of 114 bits will be loaded into one burst to transmit (refer FIG. 10).

Different from voices services, GPRS packet data service is asymmetric and independent in terms of downlink and uplink radio resources allocation. Also there are correspondingly packet data channels (PDCH) are defined for packet transmission purposes. Still follow the GSM frame and slot structures, every frame has 8 time slots and naturally defined 8 PDCHs. Packet logical channels will be allocated to those PDCH according to a scheduler. Those logical channels maybe characterized as Packet Broadcast Channel (PBCH), Packet Common Control Channel (PCCCH) and Packet Traffic Channel (PTCH). Each category of the logical channels is further specified by their purpose and directions.
Packet Broadcast Control Channel (PBCCH)
   Frequency correction channel.
   Time synchronization channel.
   Broadcast control channel for general information on the base station.
   Packet broadcast channels to broadcast parameters that MS needs to access network for packet transmission.
Packet Common Control Channel (PCCCH)
   Paging (PPCH).
   Random Access (PRACH).
   Packet Access Grant (PAGCH).
   Packet Notification (PNCH).
Packet Dedicated Control Channel (PDCCH).
   Slow Associated Control Channel (SACCH) for radio signal measurements and data and for SMS transfer during calls.
   Fast Associated Control Channel (FACCH) for one Traffic Channel (TCH).
   Stand-alone Dedicated Control Channel (SDCCH).
Packet traffic channels (TCH) for data and voice

One important concept of GPRS is Temporary Block Flow (TBF) which supports unidirectional data transmission on PDCH and is a virtual connection between Base station MAC and mobile MAC. TBF is uniquely tagged by a Temporary Flow Identifier (TFI) which is represented by 7 bits for uplink and 5 bits for downlink.

One scenario to make a data transfer from mobile to base station: Mobile send a packet channel request (PCR) message to base station over PRACH; upon receiving it, base station will respond a packet uplink assignment (PUA) message which informs the mobile the radio resources assigned to it; PUA may include channel frequency, time slots, uplink state flag (USF), TFI, PACCH and indication that the connection is close ended or open ended etc.; Mobile starts to transfer its data with the assigned radio resources and tagged with a temporary logical link identifier (TLLI); Base station then send a message to tell the mobile whether it received the packet or not. TBF is terminated when base station sends the acknowledgement message.

One scenario to make a data transfer from base station to mobile: Base station uses PPCH to page the destination mobile; mobile replies with PRACH and requests downlink radio resources and base station replies with PAGCH and others are similar to mobile initiated call.

IEEE 802.11a, b, g&n a.k.a WiFi (wireless fidelity) is another widely adopted wireless standard.

The 802.11a standard uses OFDM modulation technology and operates in the 5 GHz U-NII band. Another similar standard, 802.11g that uses OFDM and operates in 2.4 GHz. Both 802.11a and 802.11g occupy a spectrum of 20 MHz and they provide variable data rates of 6, 9, 12, 18, 24, 36, 48, and 54 Mbps. The IEEE 802.11n standard is an amendment which improves the previous 802.11 standards by using multiple antennas and 40 MHz bandwidth to further increase the data throughput.

Conventional WiFi OFDM signal uses 64 points FFT (Fast Fourier Transform) and has 52 subcarriers which include 48 data subcarriers and four pilot subcarriers; the subcarriers can be modulated using BPSK, QPSK, 16QAM or 64QAM. The total symbol duration is 4 μs that includes an useful symbol duration of 3.2 μs and a guard interval of 0.8 μs. Subcarriers are spaced apart by 312.5 kHz (20 MHz/64) so that the signal actually occupies a bandwidth of 16.25 (52×312.5 kHz) MHz in theory.

The foregoing objects and advantages of the invention are illustrative that can be achieved by various exemplary embodiments and are not intended to be exhaustive or to limit the possible advantages which can be realized. Thus, these and other objects and advantages of the various exemplary embodiments will be apparent from the description herein or can be learned from practicing the various exemplary embodiments, both as embodied herein or as modified in view of any variation that may be apparent or equivalent to those persons skilled in the art.

### 3. SUMMARY OF THE INVENTION

As TV channel bandwidth is 6 MHz (8 MHz and 7 MHz are used in other geographic regions), a GSM channel needs two 200 kHz and WiFi needs 20 or 10 or 5 MHz, spectrum planning and WiFi devices reconfiguration have to be done before using TVWS.

We will provide brief summaries of various exemplary embodiments. Some simplifications and omissions may be made in the following summary, which is intended to highlight and introduce some aspects of the various exemplary embodiments, but not to limit the scope of the invention. Detailed descriptions of a preferred exemplary embodiment are adequate to those having skills in the art to make and to use the inventive system concepts and methods.

A GSM device (refer to FIG. 11) comprise an antenna, a duplexer to be able to transmit and receive simultaneously, an RF processor to regulate the transmit signal and the receive signal in analog format, a baseband processor to encode the signal for transmit and to decode the received signal and a coprocessor for L2/L3/MAC processing and a SIM (Sub Scriber Identification Module) to personalize the device.

A WiFi device (refer to FIG. 12), comprise an antenna, a transmit-and-receive switch, an RF modules to regulate the transmit signal and the receive signal in analog format, a baseband processor to encode the signal for transmit and to decode the received signal and a coprocessor for MAC processing.

The invention provides systems and methods to integrate GSM and WiFi seamlessly

The invention also provides a cost effective solution for wireless networks convergence under GSM network or other wide area wireless network.

Embodiments provide the system architecture on how to co-locate GSM system or other wireless systems with WiFi system to operate within a same TV channel or other frequency bands including GSM current spectrum and TD-SCDMA bands.

Still other embodiments employ GSM to operate local networks such as WiFi or Femto networks or home gateways.

### 4. DESCRIPTION OF DRAWINGS

The present invention will be further understood from the following detailed description and reference drawings.

FIG. 1 illustrates USA TV channel allocations before Jun. 12, 2009

FIG. 2 illustrates USA TV channel allocations after Jun. 12, 2009

FIG. 3 exemplifies GSM FDD-TDD frequency channel and time slot structure

FIG. 4 shows the GSM standardized spectrum mask

FIG. 5 illustrates 5 typical GSM slot/burst types.

FIG. 6 illustrates GSM slot/frame numerology.

FIG. 7 illustrates GSM full rate speech coding process.

FIG. 8 illustrates how 20 ms voice coded bits are interleaved within 8 consecutive frames.

FIG. 9 illustrates the start and stop of a GSMK burst.

FIG. 10 illustrate how GPRS radio data block is mapped to GSM bursts

FIG. 11 highlights the key parts of a GSM device

FIG. 12 highlights the key parts of a WiFi device

FIG. 13a shows the WiFi spectrum mask for 20 MHz channel and FIG. 13b shows the corresponding spectrum mask if 5 MHz channel is allocated

FIG. 14 provides how to pack GSM system and WiFi system within 6 MHz TV channel

FIG. 15 shows how to pack GSM system and WiFi system within 8 MHz TV channel

FIG. 16 shows how to pack GSM system and WiFi system within 7 MHz TV channel

FIG. 17 shows how to pack CDMA system and WiFi system within 8 MHz TV channel

FIG. 18 shows how to pack GSM system and 1xEVDO system and WiFi system within 7 MHz TV channel

FIG. 19 illustrates how to pack GSM system and TD-SCDMA system and WiFi system within 8 MHz TV channel

FIG. 20 illustrates GSM operated WiFi system architecture

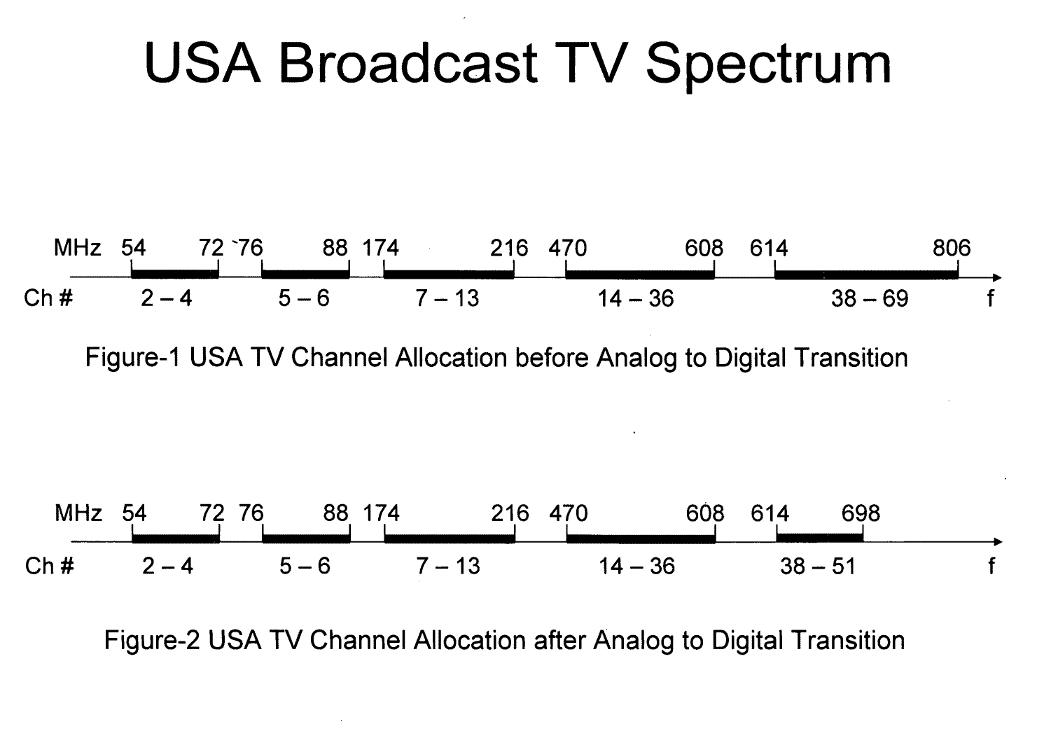

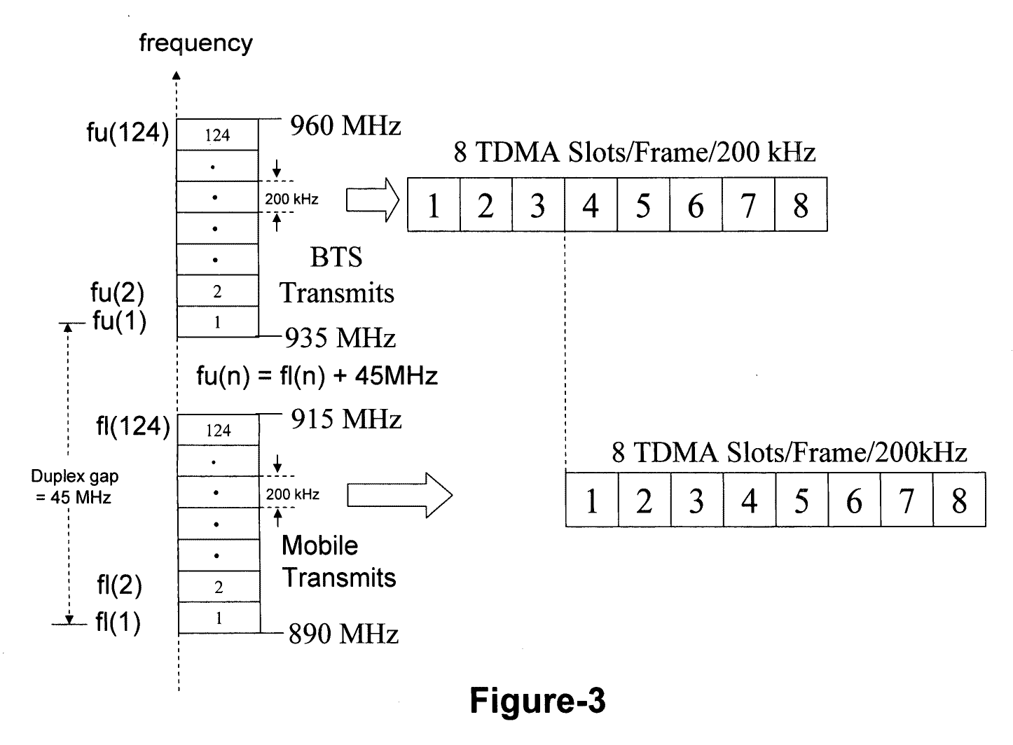

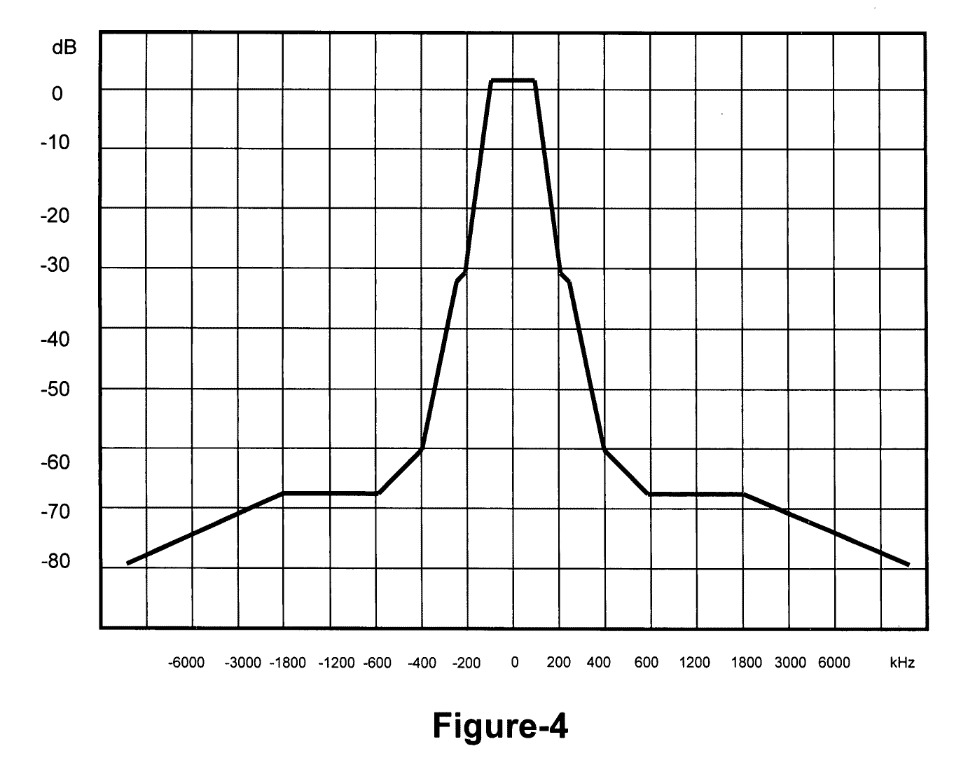

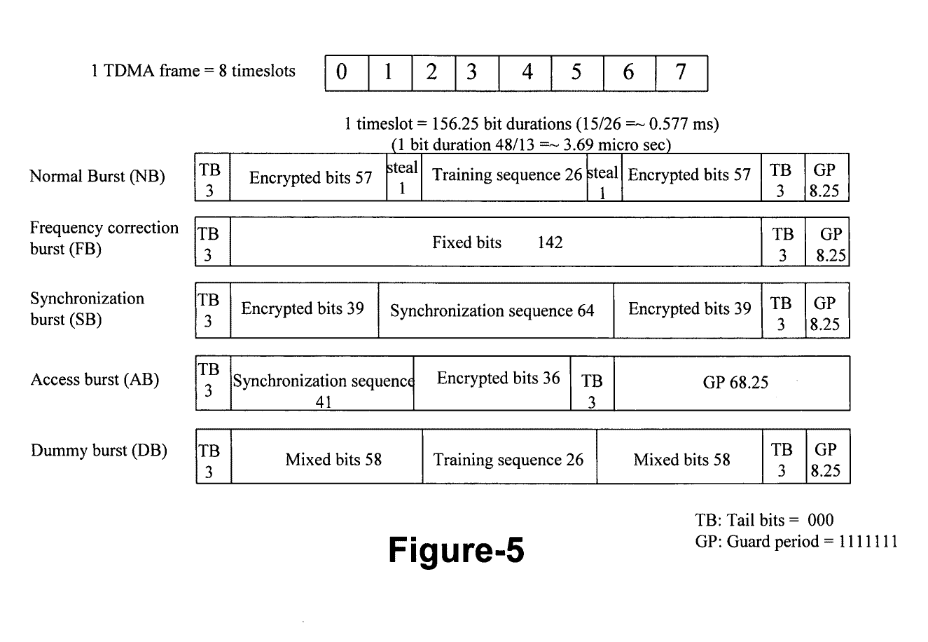

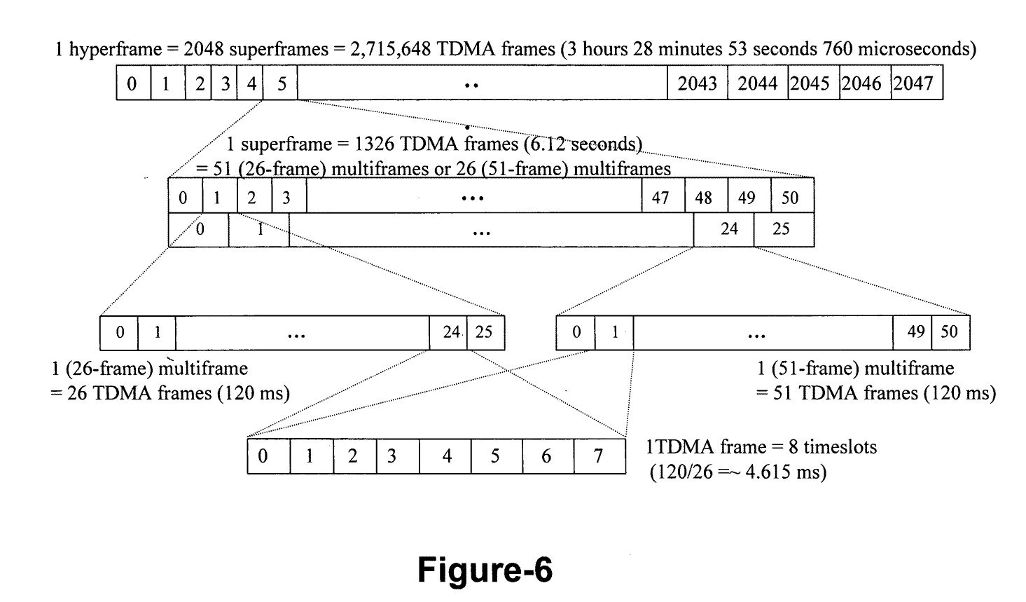

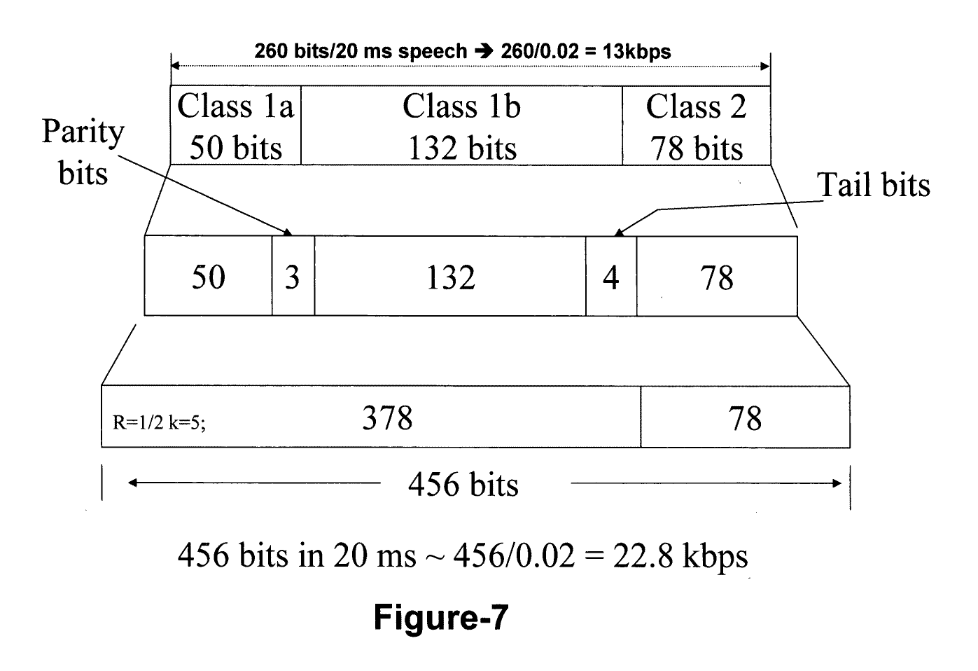

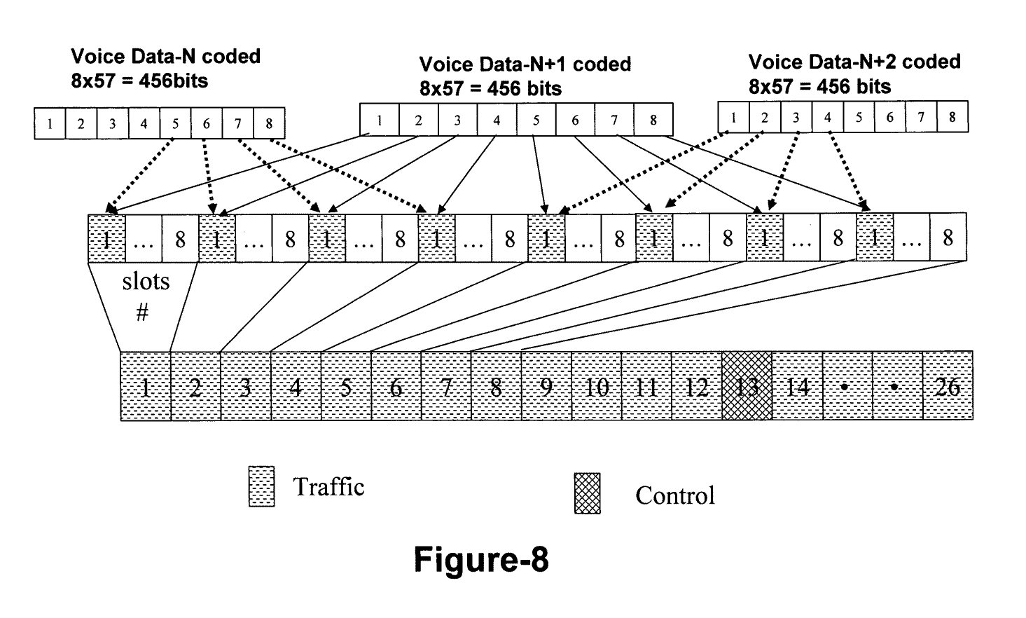

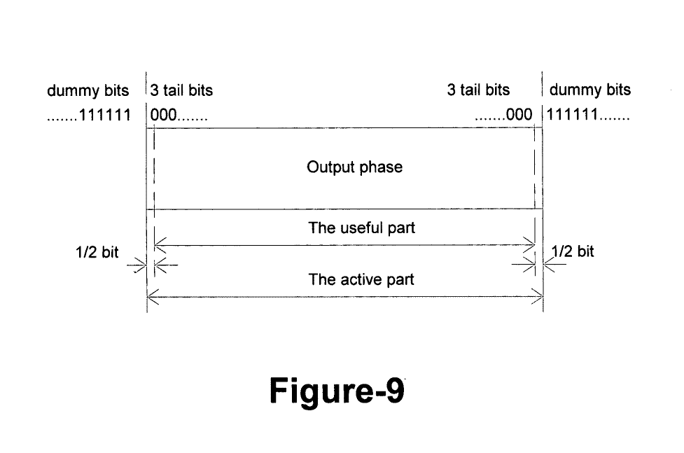

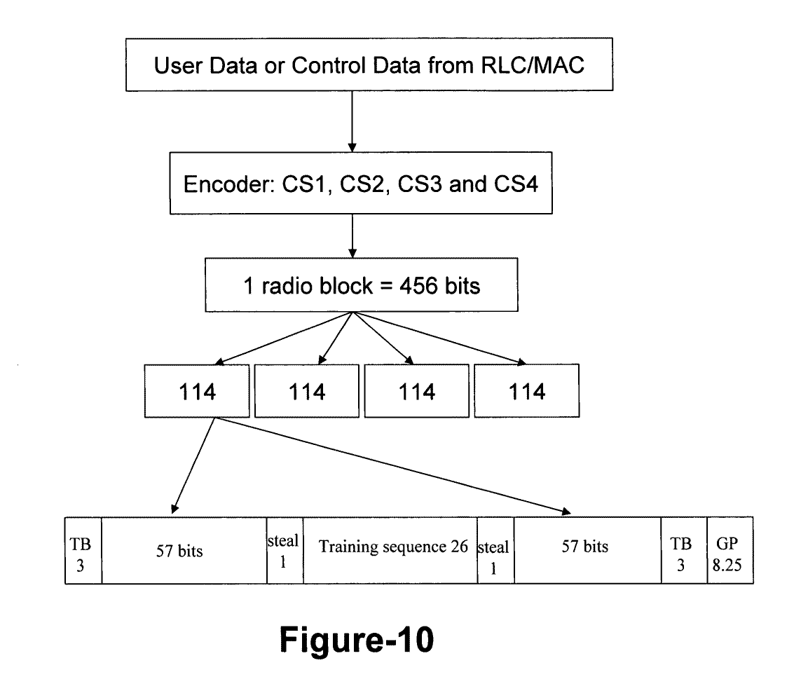

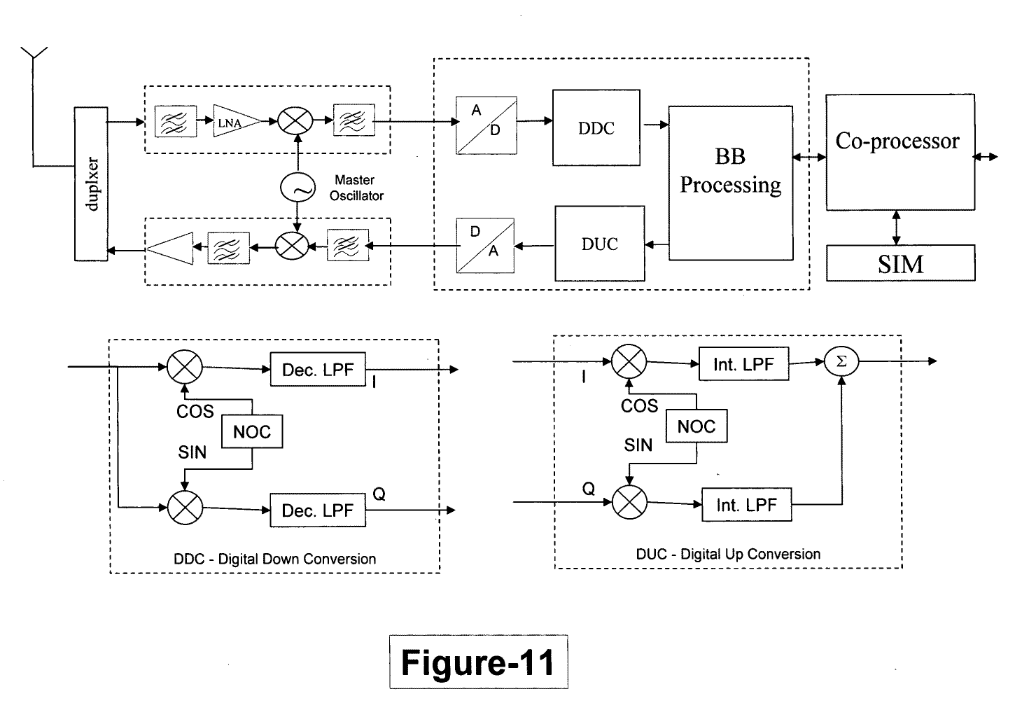

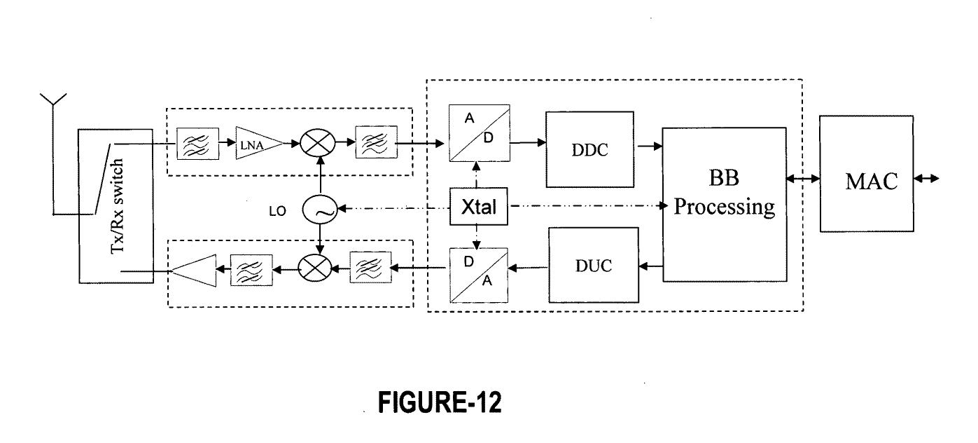

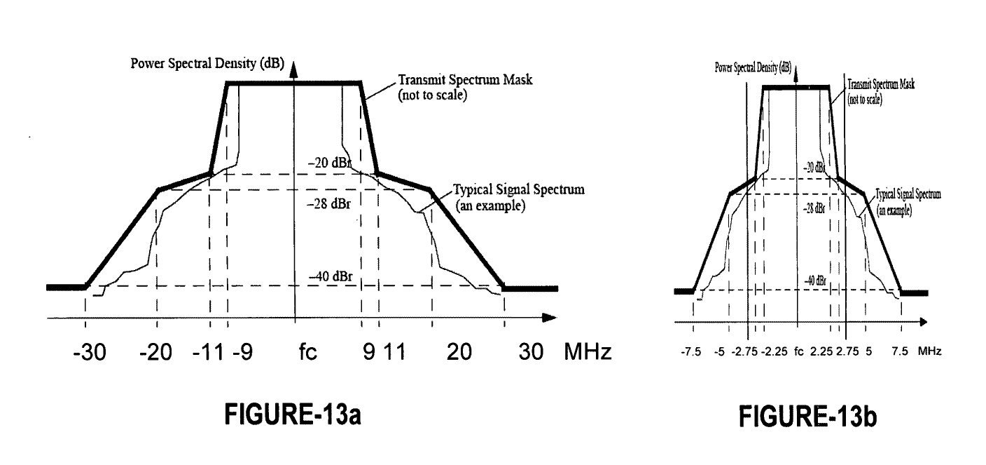

### 5. DETAILED DESCRIPTION OF THE INVENTION

GSM system is the most popular wide area wireless network with low data rate services while WiFi is the most popular local area wireless network and can support high speed wireless internet. They have been designed with different philosophies and operate in different bands. How to seamlessly bundle them together is a challenge. Existing technologies usually glue them together and use one of them exclusively. In the whole world, there are 3 types of TV channels, i.e. 6 MHz, 7 MHz and 8 MHz. To operate WiFi system in each TV channel alone will be a big waste if not redesign the WiFi chip.

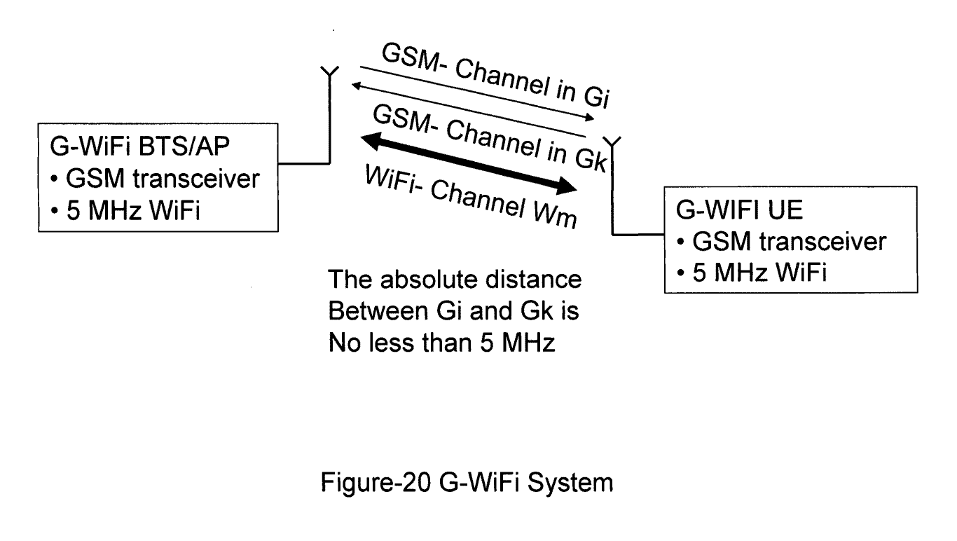

There is an illustrated G-WiFi system (refer to FIG. 20) which has a G-WiFi base station or Access point and G-WiFi terminals.

G-WiFi base station comprising a GSM transceiver unit of 200 kHz spectrum and G-WiFi transceiver unit of 5 MHz spectrum both use TV spectrum.

G-WiFi base station or access point shall be uniquely identified by an IP address or MAC address or a pre-defined ID.

G-WiFi terminal comprises of a GSM transceiver and a 5 MHz WiFi transceiver.

G-WiGi terminal shall be uniquely identified by an IP address or MAC address or a pre-defined number.

GSM unit and WiFi unit has a master-slave relationship and GSM base station or access point broadcasts G-WiFi system information (GSI) regularly and WiFi unit is controlled by GSM system to turn on/off. The GSI comprises base station/access point ID, frequency and time synchronization bursts, base station geo-location, random access priority, etc. G-WiFi terminal will regularly acquire and decode the system information to keep being associated with a G-WiFi base station or access point.

When a call initiated from network side, G-WiFi base station or access point will be responsible to ping the destination terminal associated with it via GSM channel; meanwhile makes a decision whether to turn on the WiFi unit or not basing on the bandwidth requirement. If it is a low data rate service (less than 200 kbps), it may just use the GSM channel to communicate with GSM unit in terminal side. If it is a high data rate (greater then 200 kbps) service, GSM unit in the base station or access point will activate the WiFi unit meanwhile will send a command to G-WiFi terminal via GSM channel to turn on its WiFi unit as well. Then WiFi units in both ends will start to communicate and provide the service. The radio resources should be released after service is completed or timeout.

When a call initiated from G-WiFi terminal, G-WiFi terminal will first send a WiFi radio resource request (WiFiRRR) message to base station via GSM channel. Upon receiving WiFiRRR, base station will reply a radio resource grant (RRG) to G-WiFi terminal meanwhile to activate the WiFi unit if it is high data rate service. The radio resources should be released after service is completed or timeout.

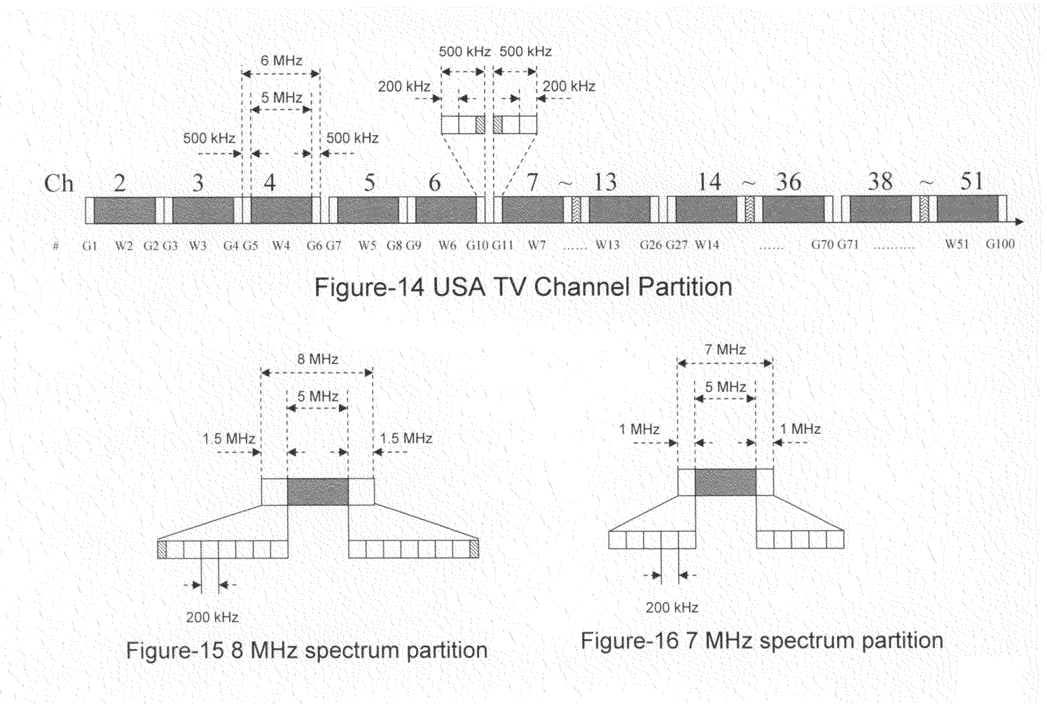

In one embodiment of the invention, GSM system and WiFi system are packed together into a TV channel of 6 MHz, or 7 MHz or 8 MHz; GSM system will use FDD and occupy 200 kHz spectrum in both uplink and downlink, while WiFi system will use TDD and occupy 5 MHz spectrum (refer to FIGS. 14, 15 and 16). GSM uplink frequency and downlink frequency may have a variable distance which is always greater or equal to 5 MHz and can be assigned independently.

In another embodiment, G-WiFi system includes a G-WiFi base station or Access point and G-WiFi terminals. G-WiFi base station comprising: a GSM transceiver unit and G-WiFi transceiver unit of 5 MHz spectrum both use TV spectrum. G-WiFi terminal comprises of a GSM transceiver and a WiFi transceiver of 5 MHz. GSM and WiFi has a master-slave relationship and GSM base station or access point broadcasts G-WiFi system information (GSI) regularly and WiFi system is controlled by GSM system to turn on/off. The GSI comprising: base station/access point ID, frequency and time synchronization bursts, base station geo-location, random access priority, etc.

In one embodiment, GSM unit of a G-WiFi base station will send a command to WiFi unit to turn it on, meanwhile GSM unit also broadcasts a G-WiFi wakeup message to wake up one or a group of G-WiFi terminals via GSM channel to let the GSM unit/units of G-WiFi terminal/terminals to wake up the WiFi unit/units collocated with GSM unit.

In another embodiment, WiFi wakeup message may comprise an occupation time interval (OTI) in terms of number of GSM time slots, an occupation identifier (OD, channel number or frequency number, service type, authorization codes etc.

In another embodiment, GSM unit of G-WiFi terminal will send a WiFi radio resource request (WiFiRRR) message to GSM unit of G-WiFi base station; upon reception of the request message, the GSM unit of the G-WiFi base station responds a radio resource grant (RRG) message meanwhile activate its WiFi counterpart; the RRG message may comprise packet size, packet type (video, voice, . . . ), emergency priority, . . . .

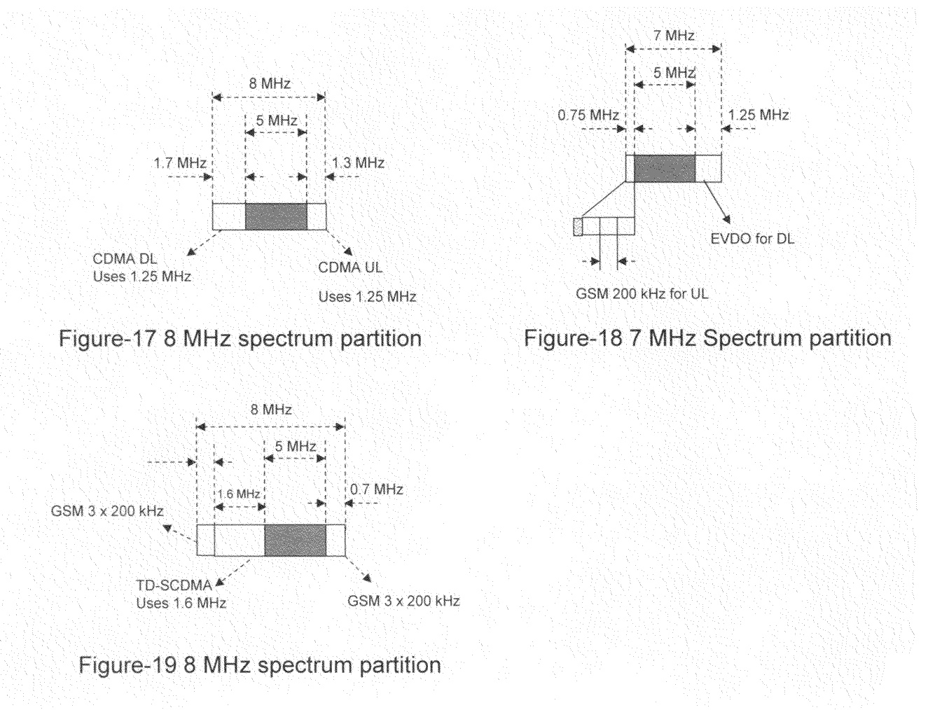

In another embodiment, CDMA system and WiFi system are packed together into a TV channel of 8 MHz; CDMA system will use FDD and occupies 1.25 MHz spectrum in both uplink and downlink, while WiFi system will use TDD and occupy 5 MHz spectrum (refer to FIG. 17).

Yet in another embodiment, 1xEVDO system or TD-SCDMA system and GSM system and WiFi system are packed into a TV channel of 7 MHz or 8 MHz. 1xEVDo uses 1.25 MHz spectrum and TD-SCDMA uses 1.6 MHz spectrum, WiFi uses 5 MHz spectrum and GSM uses 200 MHz spectrum for uplink or for downlink (refer to FIGS. 18 and 19).

We claim:

1. A G-WiFi system comprising a G-WiFi base station or Access point and G-WiFi terminals; G-WiFi base station comprising a GSM transceiver unit, G-WiFi transceiver unit of 5 MHz spectrum and they share a TV spectrum; G-WiFi terminal comprising a GSM transceiver and a WiFi transceiver or other transceivers using TV spectrum; GSM and WiFi has a master-slave relationship and GSM base station or access point broadcasts G-WiFi system information (GSI) regularly and WiFi system is controlled by GSM system to turn on/off; WiFi system will calibrate and synchronize its timing with GSM timing.

2. A G-WiFi system as claimed in claim 1 comprises the GSM transceiver uses 200 kHz spectrum on the edges of a TV channel while WiFi transceiver uses 5 MHz spectrum in the middle of a TV channel.

3. A G-WiFi system as claimed in claim 2 where GSM transceiver may choose a 200 kHz channel for uplink or downlink transmission from another TV channel and the distance between unlink frequency and downlink frequency may vary and terminal transmit frequency maybe higher than base station transmission frequency.

4. A G-WiFi system as claimed in claim 1 may contain GSM unit and WiFi unit and have a master-slave relationship and WiFi unit is under the control of GSM unit.

5. A GSM unit as claimed in claim 4 will activate/de-activate WiFi unit according to the services requirement.

6. A G-WiFi base station or access point as claimed in claim 1 shall broadcast the G-WiFi system information (GSI) regularly via a GSM channel and GSI comprising: base station/access point ID, frequency and time synchronization bursts, base station geo-location, random access priority, backup frequency, antenna characteristics etc.

7. A G-WiFi base station or access point as claimed in claim 1 shall activate its collocated WiFi unit meanwhile send a command to G-WiFi terminal via GSM channel to turn on the WiFi units on both ends and start communication until service is completed or time out.

8. A G-WiFi terminal as claim in claim 1 may send a WiFi radio resource request (WiFiRRR) message to G-WiFi base station or access point via GSM channel and G-WiFi base station shall respond a radio resource grant (RRG) message meanwhile to activate the WiFi units in both ends via GSM channel.

9. WiFiRRR message as claimed in claim 8 comprising: service type, QoS requirements, link quality indicator, priority level, frequency preference, frequency occupation time interval etc.

10. RRG message as claimed in claim 8 comprising: an occupation time interval (OTI) in terms of number of GSM time slots or frames, an occupation identifier (OI), channel number or frequency number, service type, authorization codes, backup frequency etc.

11. A method to allow GSM system and WiFi or other wireless systems and WiFi to share a TV channel comprising: WiFi uses the middle part of a TV channel/TV channels while other system uses the edges of a TV channel/TV channels.

12. A method to allow a GSM system and a WiFi system to share a spectrum as claimed in claim 11 comprising: GSM system uses the left edges and right edges of a TV channel while WiFi uses the middle 5 MHz of a TV channel.

13. A method to allow a GSM system and a WiFi system to share a spectrum as claimed in claim 12 contain that GSM spectrum are labeled as Gk and WiFi spectrum are labeled as Wn, and G-WiFi may assign any Gk for uplink transmission and Gm for downlink transmission and k not equal to m, and Gk and Gm has a minimum distance of 5 MHz.

14. A method as claimed in claim 11 may pack a CDMA system with a WiFi system. CDMA will use 1.25 MHz on the left side and right hand side of a TV channel while WiFi will occupy 5 MHz in the middle.

15. A method as claimed in claim 11 may pack GSM and/or TD-SCDMA system with a WiFi system. TD-SCDMA will use 1.6 MHz on the left or right hand side of a TV channel while WiFi will occupy 5 MHz in the middle, the remained spectrum will be assigned to GSM system.

16. A method as claimed in claim 11 may pack GSM and 1xEVDO or TD-SCDMA or WCDMA or LTE into a TV channel.
